(19) United States
(12) Patent Application Publication
(10) Pub. No.: US 2007/0079336 A1
(43) Pub. Date: Apr. 5, 2007

(54) Telephone-controlled TV set and method therefor

(76) Inventors: Xiao-Guang Li, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,329

(22) Filed: Jul. 27, 2006

(30) Foreign Application Priority Data
Aug. 5, 2005 (CN) 200510036444.1

(51) Int. Cl. H04N 7/16; H04N 7/00; H04N 7/173; H04N 5/445; G06F 3/00; H04N 11/00; G06F 13/00

(52) U.S. Cl. 725/58; 725/25; 725/133; 725/141; 348/552

(57) ABSTRACT

A telephone-controlled television (TV) set (30) includes: a memory (311) for storing user-defined locking/unlocking information used to control a switch of the TV set between a locking state and a non-locking state; a communication port (312) connected with a telephone network (20), for receiving an incoming call from a telephone (10) via the telephone network; a interactive voice response system (315) connected to the communication port, for answering the incoming call and prompting a caller of the incoming call to input control information; a state controlling unit (303) for computing a comparing result between the control information and the user-defined locking/unlocking information, and determining whether to unlock the TV set according to the comparing result if the TV is in the locking state; and a switching circuit (304) under control of the state controlling unit, for switching on or off, respectively, unlocking or locking the TV set.

### TECHNICAL FIELD

The present invention relates to television sets, and particularly to a telephone-controlled television set and method therefor.

### RELATED ART

With the ongoing development of TV technology, especially with the advent of cable TV and satellite TV, rich and colorful programs have been brought to homes and have strongly attracted viewers. People spend way much time watching television to entertain oneself as well as to acquire knowledge. However, watching TV should be minimized. The reasons are as follows:

First of all, watching TV over a long extended period of time affects viewers' physical health, especially affecting viewers' eyes. Scientists have found out that prolonged exposure to artificial light may alter human cells, thus pose a danger to human health. Therefore, long and continuous TV exposure might well be a physical risk to human beings.

Secondly, a growing number of movies and shows depict violence and sex for the sole purpose of an added image effect. However, a spectrum of viewers, such as children may take this as a norm, blindly portraying impossible acts shown on TV in real life.

Children commonly have less self-control and weaker judgment to distinguish right from wrong. They may indulge in watching TV and acquire wrong experiences from the TV if not guided with adult supervision. However, adults are usually busy making a living and resulting in little time to spend at home and guide and supervise their children.

Therefore, there is a need for providing the adults with a solution to prevent their children from watching TV irresponsibly.

### SUMMARY

A telephone-controlled TV set is provided in accordance with a preferred embodiment. The telephoned-controlled television (TV) set includes: a memory for storing user-defined locking/unlocking information, the locking/unlocking information being used to control a switch of the TV set between a locking state and a non-locking state; a communication port connected with a telephone network, for receiving an incoming call from a telephone via the telephone network; a interactive voice response system connected to the communication port, for answering the incoming call and prompting a caller of the incoming call to input control information; a state controlling unit for computing a comparing result between the control information and the user-defined locking/unlocking information, and determining whether to unlock the TV set according to the comparing result if the TV is in the locking state; and a switching circuit under control of the state controlling unit, for switching on or off, respectively, unlocking or locking the TV set.

A method for controlling a television (TV) set using a telephone is also provided, the method includes the steps of: a) predefining locking/unlocking information on the TV set, and locking the TV set; b) receiving an incoming call from a telephone via a telephone network, and automatically answer the incoming call at the TV set; c) receiving control information from the telephone, and determining whether the control information accords with the locking/unlocking information; and d) unlocking the TV set if the control information accords with the locking/unlocking information.

Other advantages and novel features will be drawn from the following detailed description with reference to the attached drawings, in which:

### BRIEF DESCRIPTION OF DRAWINGS

FIG. 1 depicts an application environment of a telephone-controlled TV set in accordance with a preferred embodiment of the present invention;

FIG. 2 depicts a schematic block diagram of the telephone-controlled TV set in accordance with the preferred embodiment of the present invention; and

FIG. 3 depicts a flowchart of a preferred method for controlling a TV set using telephones in accordance with another preferred embodiment.

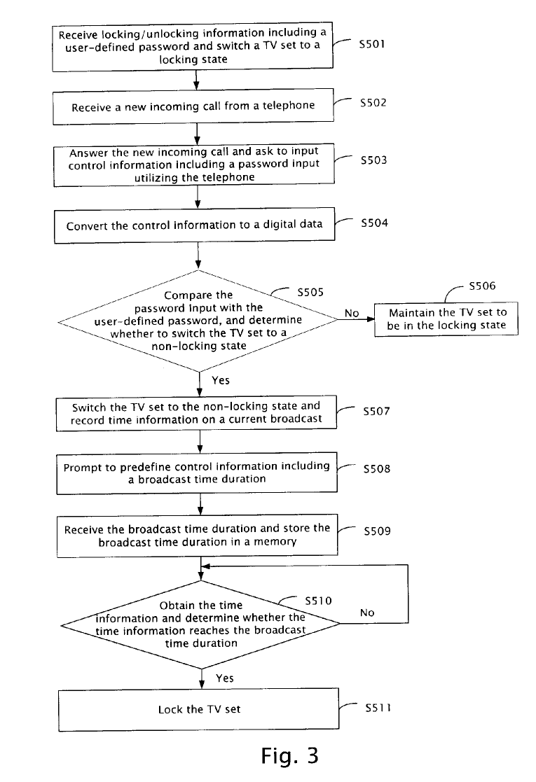

### DETAILED DESCRIPTION OF THE EMBODIMENTS

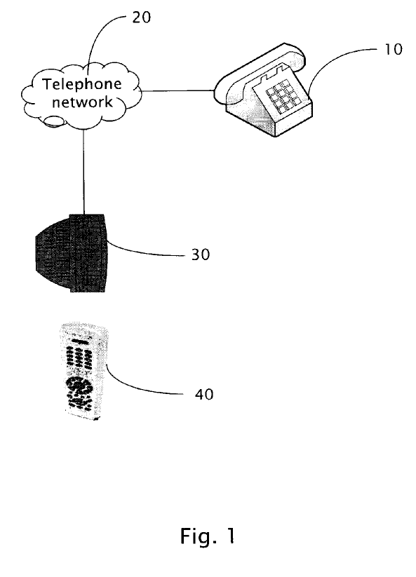

Referring to FIG. 1, shown is an application environment of a telephone-controlled TV set (hereinafter simplified as “the TV set”) in accordance with a preferred embodiment. The TV set 30 includes a locking state and a non-locking state. In the non-locking state, the TV set 30 is allowed to broadcast all programs. On the contrary, in the locking state, the TV set 30 is prevented from broadcasting programs. The TV set 30 is switched between the locking state and the non-locking state by a control device (e.g., a remote control 40).

In the locking state, the TV set 30 can receive control information from a telephone 10 via a telephone network 20. The control information then switches the TV set 30 to the non-locking state, and controls a broadcast time duration and channels that the TV set 30 broadcasts. Therefore, via this configuration, guardians are able to lock the TV set 30 utilizing the remote control 40, thus preventing minors from watching TV irresponsibly.

Minors are able to view programs with the TV set 30 only after receiving an allowance from their guardians. The minors would request permission from their guardians to unlock the TV set 30. If granted, the guardians utilize a telephone (e.g., the telephone 10) to unlock the TV set 30. Furthermore, the guardians can utilize the telephone 10 to define the broadcast time duration and the channels minors can view and thus preventing the minors from watching TV irresponsibly.

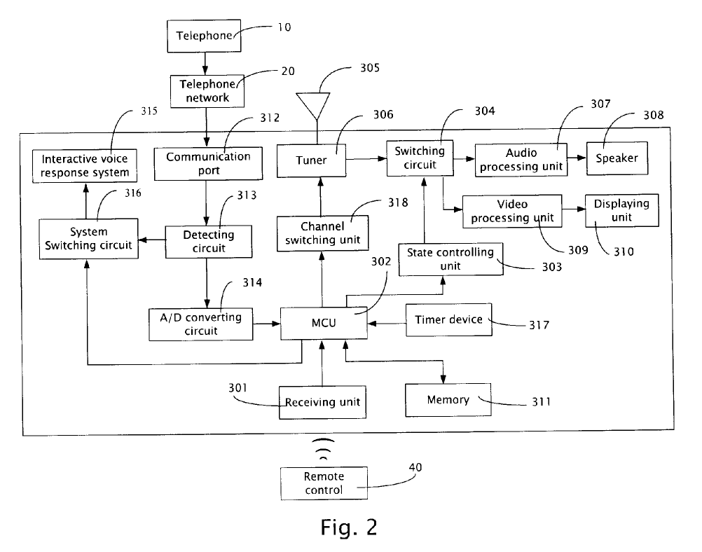

Referring to FIG. 2, shown is a schematic block diagram of the TV set 30. The TV set 20 uses an antenna 305 to receive a plurality of television signals. The antenna 207 transmits the received television signals to a tuner 206. The tuner 206 selects a television signal based upon a channel select command. The selected television signal is then divided into an audio signal and a video signal. The audio signal is sequentially transmitted to an audio processing unit 307 for processing and finally broadcasted by a speaker 212. Simultaneously, the video signal is sequentially transmitted to a video processing unit 309 and finally broadcasted by a display unit 214.

The TV set 20 receives commands including a state switching command from the remote control 40. The commands produced by the remote control 10 are picked up by a receiving unit 301 of the TV set 20 and are transmitted to a microcontroller Unit (MCU) 202 for processing. The MCU 302 cooperates with a memory 311 and controls a switch of the TV set 30 in accordance with the state switching command.

The memory 311 stores locking/unlocking information. The locking/unlocking information is defined by users and includes a password (hereinafter “the user-defined password”). Each time the users press a state switching button installed on the control device (e.g., the remote control device), a state switching command is produced and causes the TV set 30 to display a user interface on the TV set 30, prompting the users to enter a password input. The TV set 30 includes a state controlling unit 303. The state controlling unit 303 receives the password input from the users transmitted by the receiving unit 301 via the MCU 302, compares the password input with the user-defined password, and switches the TV set 30 between the locking state and the unlocking state if the password input is consistent with the user-defined password.

The TV set 30 further includes a switching unit 304 interposed between the tuner 306, the audio processing unit 307, and the video processing unit 309. In the non-locking state, the state controlling unit 303 controls the switching unit 304 to be on, allowing the TV set 30 to broadcast programs to the users. In contrast, in the locking state, the state controlling unit 303 controls the switching unit 304 to be off, so that the TV set 30 is unable to broadcast anything.

The TV set 30 is further equipped with a communication port 312. The communication port 312 is configured to receive a new incoming call from the telephone 10 via the telephone network 20. The new incoming call is put through to an interactive voice response system 315 sequentially via a detecting circuit 313 and an interactive voice response system switching circuit (hereinafter “the system switching circuit 316”). The interactive voice response system 315 then automatically answers the new incoming call and asks a caller of the new incoming call to input control information utilizing the telephone 10. For example, the interactive voice response system 315 asks the caller to enter the password input. The control information inputted by the caller is transmitted to an A/D converting circuit 314 by the detecting circuit 313. The A/D converting circuit 314 converts the control information to digital data and transmits the digital data to the MCU 302. The state controlling unit 303 obtains the password input entered by the caller from the MCU 302, compares the password input with the user-defined password, and determines whether to switch the TV set 30 from the locking state to the non-locking state according to the comparison result. If the password input is consistent with the user-defined password, the state controlling unit 303 switches the TV set 30 from the locking state to the non-locking state.

The interactive voice response system 315 further asks the caller to predefine control information including a broadcast time duration. The broadcast time duration is then stored in the memory 311 by the MCU 302, and used to control the TV set 30 only to broadcast programs for a time period corresponding to the broadcast time duration after the TV set 30 is switched to the non-locking state using the telephone 10. The TV set 30 includes a timer device 317. In one embodiment, the timer device 317 informs the MCU 302 each time a current broadcast has been broadcasting programs for the time period of the broadcast time duration. The MCU 302 then controls the state controlling unit 303 to switch off the switching circuit 304, the TV set 30 is then locked.

In an alternative embodiment, the timer device 317 records time information on the current broadcast time. The MCU 302 obtains the time information from the timer device 317 in real-time, compares the time information with the broadcast time duration, and determines whether to lock the TV set 30 according to the comparison result.

In an alternative embodiment, the interactive voice response system 315 may further ask the caller to predefine control information including channels. The Channels are permitted to broadcast after the TV set 30 is switched to the non-locking state using the telephone 10 and hereinafter are referred to as “the viewable channels.” Channel numbers or other identifiers of the viewable channels are stored in the memory 311 by the MCU 302, and used to control the TV set 30 to broadcast only the viewable channels after the TV set 30 is switched to the non-locking state using the telephone 10.

The MCU 302 receives a channel select command from the control device (e.g., the remote control 40), and determines whether a channel selected by the user using the channel select command is a subset of the viewable channels. If yes, the MCU 302 controls a channel switching unit 318 to switch the TV set 30 to the selected channel. If not, in one embodiment, the MCU 302 ignores the channel switching intention of the user. The TV set 30 continues to broadcast a current viewable channel to the user. In an alternative embodiment, the MCU 302 controls the state controlling unit 303 to switch off the switching circuit 304, thus to broadcast nothing to the user.

According to the preferred embodiments, each time the caller intents to use the telephone 30 to unlock the TV set 30, the system switching circuit 316 is controlled to be on by the MCU 302 in accordance with an “on” command sent from the control device (e.g., the remote control 40) by the user, thus enabling the interactive voice response system 315. After the TV set 30 is switched to the non-locking state and the control information has been input, the system switching circuit 316 switches off under control of the MCU 302, thus to interrupt further communications between the telephone 10 and the interactive voice response system 315.

The control information including the broadcast time duration and the viewable channels can also be predefined using the control device, and are stored in the memory 311 as default control information. The caller may redefine the broadcast time duration and the viewable channels using the telephone 10 as described above or just select the default control information according to the prompt of the interactive voice response system 315.

Referring to FIG. 2, a flowchart of a method for controlling the TV set 30 using the telephone 10 is briefly shown. First in step S501, The TV set 30 receives locking/unlocking information including the use-defined password of the TV set 30 from the control device, and switches itself to the locking state in accordance with a state switching command from the control device. In step S502, the communication port 312 of the TV set 30 receives the new incoming call from the telephone 10 via the telephone network 20. The new incoming call is then put through to the interactive voice response system 315. In step S503, the interactive voice response system 315 automatically answers the new incoming call and asks the caller to input control information including the password input utilizing the telephone 10. In step S504, the control information input by the caller is transmitted to the A/D converting circuit 314, and the A/D converting circuit 314 accordingly converts the control information to digital data, and then transmits the digital data to the MCU (micro-controller unit) 302. In step S505, the state controlling unit 303 obtains the password input entered by the caller from the MCU 302, compares the password input with the user-defined password, and determines whether to switch the TV set 30 from the locking state to the non-locking state according to the comparison result. If the password input is inconsistent with the predefined password, in step S506, the state controlling unit 303 controls the switching circuit 304 to be off, thus maintaining the TV set 30 to be in the locking state, and the procedure is finished.

If the password input is consistent with the predefined password, in step S507, the state controlling unit 303 controls the switching circuit 304 to be on, thus switches the TV set 30 to the non-locking state. A current broadcast begins and the MCU 302 starts the timer device 317 to start recording time information on the current broadcast. In step S508, the interactive voice response system 315 prompts the caller to predefined control information including the broadcast time duration. In step S509, the MCU 302 receives the broadcast time duration from the caller and stores the broadcast time duration in the memory 311. In step S510, the MCU 302 obtains the time information on the current broadcast from the timer device 317 in real-time, and determines whether the time information on the current broadcast reaches the broadcast time duration. If the time information on the current broadcast does not reach the broadcast time duration, the procedure returns to step S510, the MCU 302 continues to obtain the time information and determines whether to lock the TV set according to the time information. If the time information on the current broadcast reaches the broadcast time duration, in step S511, the state controlling unit 303 controls the switching circuit to be off, thus to lock the TV set. The procedure is accordingly finished.

In the above procedure, the interactive voice response system 315 may further prompts the caller to predefined control information including viewable channels. The MCU 302 receives channel numbers or other identifiers of the viewable channels from the caller and stores the channel numbers or other identifiers in the memory 311. Each time receiving a channel select command from the control device, the MCU 302 determines whether a channel selected by the user using the channel select command is included in the viewable channels. If yes, the MCU 302 controls a channel switching unit 318 to switch the TV set 30 to the selected channel. If not, the MCU 302 controls the TV set 30 via the channel switching unit 318 to broadcast a current viewable channel or nothing to the user.

In an alternative embodiment of the method of FIG. 2, the MCU 302 sets the timer device 317 to record time information on the current broadcast after the broadcast time duration is received from the caller. Each time the time information on the current broadcast reaches the broadcast time duration, the timer device 317 informs the MCU 302, and the MCU 302 accordingly controls the state controlling unit 303 to switch off the switching unit 304, thus locking the TV set 30.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A television (TV) set, comprising:
a memory for storing a user-defined locking/unlocking information, the user-defined locking/unlocking information being predetermined to control a switch of the TV set between a locking state and a non-locking state;
a communication port connected with a telephone network, for receiving an incoming call from a telephone via the telephone network;
an interactive voice response system connected to the communication port, for answering the incoming call and prompting a caller of the incoming call to enter control information;
a state controlling unit for computing a comparing result between the control information and the user-defined locking/unlocking information, and determining whether to unlock the TV set according to the comparing result if the TV is in the locking state; and
a switching circuit under control of the state controlling unit, for switching on or off, respectively, unlocking or locking the TV set.

2. The TV set as claimed in claim 1, further comprising a control device for producing commands to control the TV set.

3. The TV set as claimed in claim 2, further comprising a microcontroller unit (MCU) for controlling the TV set in accordance with the commands from the control device.

4. The TV set as claimed in claim 3, further comprising an interactive voice response system switching circuit to enable and disable the interactive voice response system under control of the MCU.

5. The TV set as claimed in claim 3, wherein the locking/unlocking information includes a user-defined password.

6. The TV set as claimed in claim 5, wherein the control information includes a password input, the state controlling unit determines whether the password input is consistent with the user-defined password, and accordingly unlocks the TV set if the password input is consistent with the user-defined password.

7. The TV set as claimed in claim 6, wherein the control information further includes a broadcast time duration, the broadcast time duration is received and stored in the memory by the MCU.

8. The TV set as claimed in claim 7, further comprising a timer device for recording a time information on a current broadcast of the TV set.

9. The TV set as claimed in claim 8, wherein the MCU controls the state controlling unit to lock the TV set if the time information on the current broadcast reaches the broadcast time duration.

10. The TV set as claimed in claim 9, wherein the control information further includes viewable channels, identifiers of which is received and stored in the memory by the MCU.

11. The TV set as claimed in claim 10, wherein the MCU controls the TV set to only broadcast the viewable channels after the TV set is switched to the non-locking state using the telephone.

12. A method for controlling a television (TV) set using a telephone, comprising the steps of:
predefining locking/unlocking information on the TV set, and locking the TV set;
receiving an incoming call from a telephone via a telephone network, and automatically answer the incoming call at the TV set;
receiving control information from the telephone, and determining whether the control information accords with the locking/unlocking information; and
unlocking the TV set if the control information accords with the locking/unlocking information.

13. The method as claimed in claim 12, further comprising the step of prompting a caller of the incoming call to input the control information using the telephone.

14. The method as claimed in claim 12, further comprising the step of continuing to lock the TV set if the control information does not accord with the locking/unlocking information.

15. The method as claimed in claim 12, wherein the locking/unlocking information comprises a user-defined password.

16. The method as claimed in claim 15, wherein the control information comprises a password input.

17. The method as claimed in claim 16, wherein the control information further comprises a broadcast time duration.

18. The method as claimed in claim 17, further comprising the step of recording time information on a time information on a current broadcast of the TV set, determining whether the time information on the current broadcast reaches the broadcast time duration, and locking the TV set if the time information on the current broadcast reaches the broadcast time duration.

19. The method as claimed in claim 18, wherein the control information further comprises viewable channels.

20. The method as claimed in claim 19, further comprising the step of controlling the TV set to broadcast the viewable channels after the TV set is unlocked by using the telephone.
